(19) United States
(12) Patent Application Publication
(10) Pub. No.: US 2016/0094683 A1
(43) Pub. Date: Mar. 31, 2016

(54) CHANNEL CONNECTION MANAGEMENT METHOD AND APPARATUS

(71) Applicant: SAMSUNG SDS CO., LTD., Seoul (KR)

(72) Inventors: Ju Seok YUN, Seoul (KR); Yong Tae KIM, Seoul (KR); Hyeong Goo KIM, Seoul (KR)

(73) Assignee: SAMSUNG SDS CO., LTD., Seoul (KR)

(21) Appl. No.: 14/865,285

(22) Filed: Sep. 25, 2015

(30) Foreign Application Priority Data
Sep. 26, 2014 (KR) 10-2014-0128976

(51) Int. Cl. H04L 29/06; H04L 29/08

(52) U.S. Cl. CPC H04L 67/42; H04L 67/10

(57) ABSTRACT

Provided are a channel connection management method comprising: registering a first command channel connected between a server and a first client; and transmitting a signal for requesting the connection of a data transmission channel to the first client through the first command channel

This application claims priority from Korean Patent Application No. 10-2014-0128976 filed on Sep. 26, 2014 in the Korean Intellectual Property Office, the disclosure of which is incorporated herein by reference in its entirety.

### BACKGROUND OF THE INVENTION

1. Field of the Invention

The present invention relates to a channel connection management method and apparatus, and more particularly, to a channel connection management method and apparatus for managing channels connected between a server and a client. 2. Description of the Related Art

A channel may be used to exchange data between a server and a client.

Generally, the client connects a channel to the server, and the server uses the connected channel only. That is, the server has to passively rely on the client for channel connection.

Therefore, it is difficult for the server to actively manage channels and adjust channel connection to the client according to its situation.

### SUMMARY OF THE INVENTION

Aspects of the present invention provide a channel connection management method and apparatus which enable a server to actively manage channels.

Aspects of the present invention also provide a channel connection management method and apparatus which can ensure the safety of a server by increasing or decreasing the number of channels connected between the server and a client according to the situation of the server.

Aspects of the present invention also provide a channel connection management method and apparatus which can increase or decrease the number of connected channels regardless of data load.

Aspects of the present invention also provide a channel connection management method and apparatus which enable a server to actively disconnect connected channels even when a malignant client connects a large number of channels to the server.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a channel connection management method including: registering a first command channel connected between a server and a first client; and transmitting a signal for requesting the connection of a data transmission channel to the first client through the first command channel.

According to another aspect of the present invention, there is provided a channel connection management method including: registering a command channel connected between a server and each client; and transmitting a signal for requesting the disconnection of a data transmission channel unused for more than a preset period of time to each client through the command channel.

According to another aspect of the present invention, there is provided a channel connection management method including: registering a first command channel connected between a server and a first client; judging a resource state of the server; and transmitting a signal for requesting the disconnection of all or some of data transmission channels currently being used to the first client through the first command channel when the judged resource state of the server is at a preset level.

According to another aspect of the present invention, there is provided a channel connection management apparatus including: a command channel registration unit which registers a first command channel connected between a server and a first client; and a channel connection request unit which transmits a signal for requesting the connection of a data transmission channel to the first client through the first command channel.

According to another aspect of the present invention, there is provided a channel connection management apparatus including: a command channel registration unit which registers a first command channel connected between a server and a first client; a disconnection request unit which transmits a signal for requesting the disconnection of a data transmission channel unused for more than a preset period of time to the first client through the first command channel; and a resource state judgment unit which judges a resource state of the server after the unused data transmission channel is disconnected, wherein when the judged resource state of the server is at a preset level, the disconnection request unit transmits a signal for requesting the disconnection of some or all of data transmission channels currently being used to the first client through the first command channel.

According to another aspect of the present invention, there is provided a computer program which is combined with hardware and stored in a medium to execute a channel connection management method.

### BRIEF DESCRIPTION OF THE DRAWINGS

The above and other aspects and features of the present invention will become more apparent by describing in detail exemplary embodiments thereof with reference to the attached drawings, in which:

FIG. 1 illustrates the configuration of a system environment to which a channel connection management apparatus according to an embodiment of the present invention is applied;

FIG. 2 is a flowchart illustrating a channel connection management method according to another embodiment of the present invention;

FIG. 3 is a flowchart illustrating a channel connection management method according to another embodiment of the present invention;

FIG. 4 is a flowchart illustrating a channel connection management method according to another embodiment of the present invention;

FIG. 5 is a block diagram of a channel connection management apparatus according to an embodiment of the present invention; and

FIG. 6 illustrates another configuration of the channel connection management apparatus of FIG. 5.

### DETAILED DESCRIPTION OF THE INVENTION

The present invention will now be described more fully with reference to the accompanying drawings, in which exemplary embodiments of the invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, steps and/or operations but do not preclude the presence or addition of one or more other components, steps and/or operations.

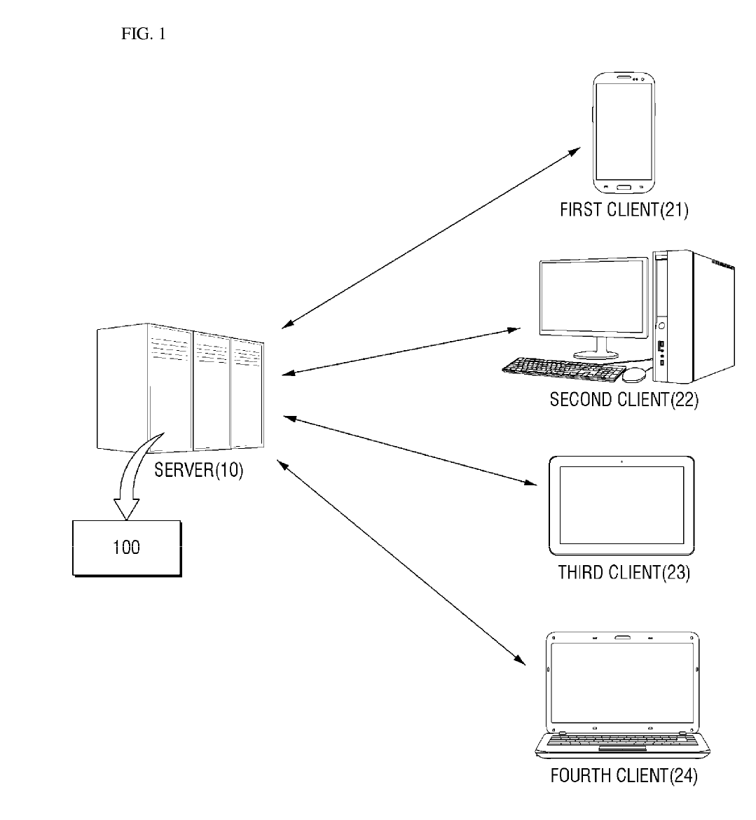

FIG. 1 illustrates the configuration of a system environment to which a channel connection management apparatus 100 according to an embodiment of the present invention is applied.

Referring to FIG. 1, the channel connection management apparatus 100 according to the embodiment of the present invention may be a separate apparatus or may be included in a server 10. In FIG. 1, the channel connection management apparatus 100 according to the embodiment of the present invention is included in the server 10.

A system to which the channel connection management apparatus 100 according to the embodiment of the present invention is applied includes the server 10 and a client (21, 22, 23, 24) which transmits and/or receives data to or from the server 10 through wireless communication.

The client (21, 22, 23, 24) connected to the server 10 may be provided in a plurality.

The client is a device that can transmit and/or receive data to or from the server 10 through wireless communication. Examples of the client may include a smartphone, a desktop computer, a tablet PC, and a notebook computer.

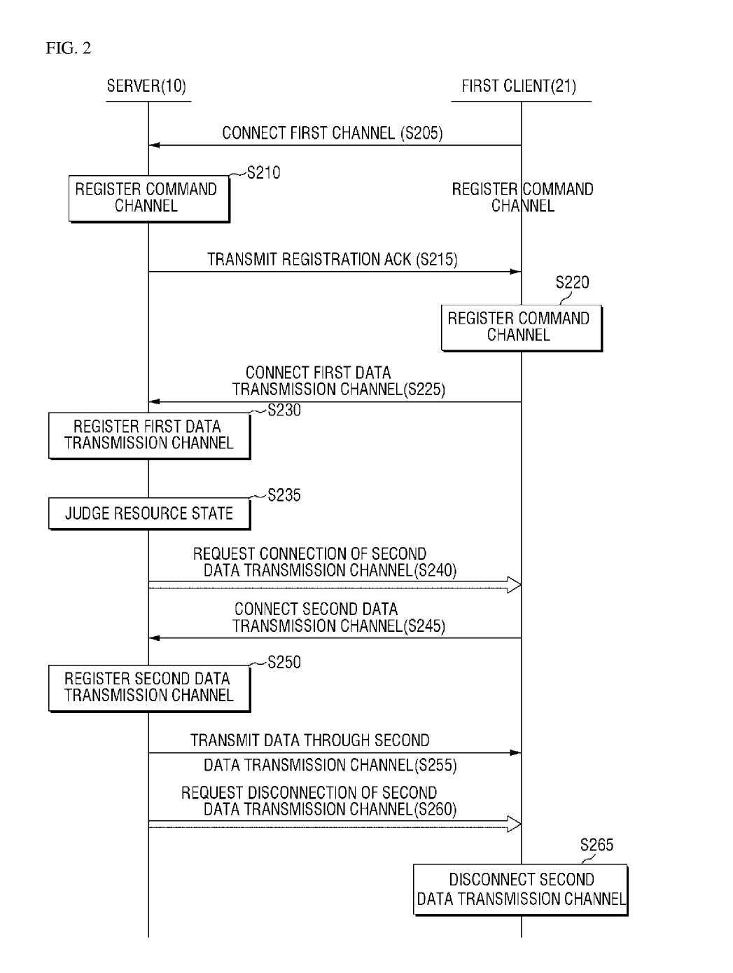

A channel connection management apparatus 100 and method according to an embodiment of the present invention uses a command channel which is identical to a data transmission/reception channel but is a dedicated channel for transmitting a preset command signal. The command channel and the operation of the channel connection management apparatus 100 and method according to the embodiment of the present invention using the command channel will be described later with reference to FIGS. 2 through 6.

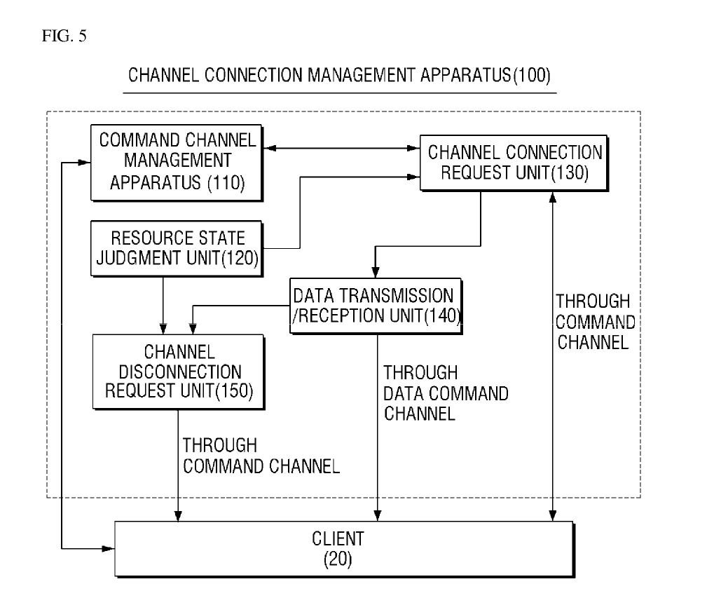

Specifically, the channel connection management apparatus 100 according to the embodiment of the present invention will be described in greater detail later with reference to FIG. 5.

The command channel is connected and registered with the server 10 and the client before a data transmission channel is connected.

The command channel is not used for transmission and reception of general data. The command channel may be used only for transmission of the preset command signal.

An example of the preset command signal is a signal transmitted by the server 10 to the client to request channel connection. Another example of the preset command signal is a signal transmitted by the server 10 to the client to request channel disconnection.

That is, the command channel may serve as a hotline for the preset command signal.

Therefore, despite the network load of the data transmission channel, the preset command signal can be immediately transmitted through the command channel. In addition, the server 10 can manage channel connection or the number of connected channels by transmitting the preset command signal through the command channel.

Specifically, examples of a method by which the server 10 manages channel connection or the number of connected channels will be described below.

Generally, the client connects a channel to the server 10 for communication between them. That is, the channel is connected in a direction from the client to the server 10. However, two-way communication is possible between the server 10 and the client through the connected channel.

Therefore, in embodiments of the present invention, when the server 10 actively performs channel connection to the client, it does not mean that the server 10 forcibly connects a channel to the client.

In embodiments of the present invention, when the server 10 actively performs channel connection to the client, it means that the server 10 induces the client to connect or disconnect a channel.

When the server 10 has data to transmit to the client, it may request the client to connect a data transmission channel. Then, the client requested by the server to connect the data transmission cannel may connect the data transmission channel to the server 10 unless it is in a special situation such as a lack of resources.

Alternatively, the server 10 may be in a good resource state and thus request the client to connect an additional data transmission channel for more efficient data transmission and reception. Then, the client requested by the server 10 to connect the additional data transmission channel may connect the additional data transmission channel.

Alternatively, the server 10 may transmit a signal for requesting the disconnection of an unused channel from among connected channels to the client. The unused channel may be a channel that has not been used for more than a preset period of time. When receiving the signal for requesting the disconnection of the unused channel from the server 10, the client may disconnect the unused channel.

Alternatively, the server 10 may need to disconnect some of the channels connected thereto due to a bad resource state. In this case, when the transmission of data currently being transmitted is completed, the server 10 may transmit a signal for requesting the disconnection of a channel to the client. In response to the signal from the server 10, the client may disconnect the channel after the transmission of the data currently being transmitted is completed instead of transmitting another data through the channel.

The above example methods used by the server 10 to manage channel connection will now be described in greater detail with reference to FIGS. 2 through 4.

FIG. 2 is a flowchart illustrating a channel connection management method according to another embodiment of the present invention.

In FIG. 2, the channel connection management method according to the current embodiment is illustrated.

To help understand the channel connection management method according to the current embodiment, the relationship between a first client 21 from among a plurality of clients and a server 10 will be described as an example.

The channel connection management method to be described with reference to FIG. 2 can be applied to the relationships between the server 10 and other clients.

Referring to FIG. 2, the first client 21 connects a channel for data transmission and reception with the server 10 (operation S205).

The channel first connected by the first client 21 may be registered as a command channel (operation S210). Specifically, the command channel between the first client 21 and the server 10 will hereinafter be referred to as a “first command channel.”

Command channels connected between other clients and the server 10 are different from the first command channel.

The first command channel may be a channel connected first between the server 10 and the first client 21.

Specifically, unlike a channel used to transmit and receive data, the first command channel remains continuously connected between the server 10 and the first client 21 while the server 10 and the first client 21 are linked to each other.

The channel used to transmit and receive data will hereinafter be referred to as a “data transmission channel.”

Unlike the first command channel, the data transmission channel may be disconnected or reconnected depending on the resource state of the server 10, the network state, etc.

In addition, the data transmission channel may include a plurality of channels at the request of the server 10 or the first client 21. However, the first command channel may be only one.

More details about the first command channel can be found in the above description of the command channel.

The server 10 may transmit a command channel registration acknowledgement (ACK) (operation S215).

The first client 21 may receive the command channel registration ACK and register the first connected channel as the command channel (operation S220).

After the connection and registration of the command channel, the first client 21 connects a first data transmission channel for data transmission and reception (operation S225).

The first client 21 can connect an additional transmission channel for data transmission or reception in view of its resource state, setting, etc.

The server 10 registers the first data transmission channel (operation S230).

The first client 21 may transmit or receive data to or from the server 10 through the first data transmission channel.

The server 10 may have data to transmit to the first client 21, or the first data transmission channel may be being used to transmit or receive another data.

In these cases, the server 10 judges its resource state (operation S235).

When the resource state of the server 10 indicates that data transmission is possible and that an additional channel can be connected, the server 10 transmits a signal for requesting the connection of a new data transmission channel (e.g., a second data transmission channel) to the first client 21 (operation S240).

A signal for requesting the connection of a new data transmission channel is a signal included in a preset command signal.

That is, the server 10 transmits the signal for requesting the connection of the new data transmission channel to the first client 21 through the first command channel. Thick arrows illustrated in FIG. 2 indicate signals transmitted through the first command channel.

The first client 21 connects the second data transmission channel unless it is in a situation of constraints such as a lack of resources (operation S245).

The server 10 registers the connected second data transmission channel (operation S250).

The server 10 may transmit intended data to the first client 21 through the second data transmission channel (operation S255).

After the transmission of the intended data through the second data transmission channel is completed, the server 10 may transmit a signal for requesting the disconnection of the second data transmission channel to the first client 21 (operation S260).

A signal for requesting the disconnection of a data transmission channel is a signal included in the preset command signal.

That is, the server 10 transmits the signal for requesting the disconnection of the second data transmission channel to the first client 21 through the first command channel (operation S260).

When the first client 21 does not have data to transmit to the server 10 through the second data transmission channel, it may disconnect the second data transmission channel (operation S265).

In the situation of FIG. 2, according to the conventional art, when the server 10 has data to transmit to the first client 21, it has to wait until it can transmit the data through an already connected channel.

Therefore, even when the server 10 has enough resources to connect an additional channel, if the first client 21 does not connect an additional channel, the server 10 has to wait until data transmission conditions become favorable.

On the other hand, according to embodiments of the present invention, when there are enough resources, an additional channel is connected to facilitate data transmission and reception.

In addition, according to embodiments of the present invention, even when all data transmission channels are being used, a signal for managing channel connection can be transmitted through the command channel. Without the command channel, the transmission of the signal for managing channel connection has to be delayed until transmission conditions become favorable.

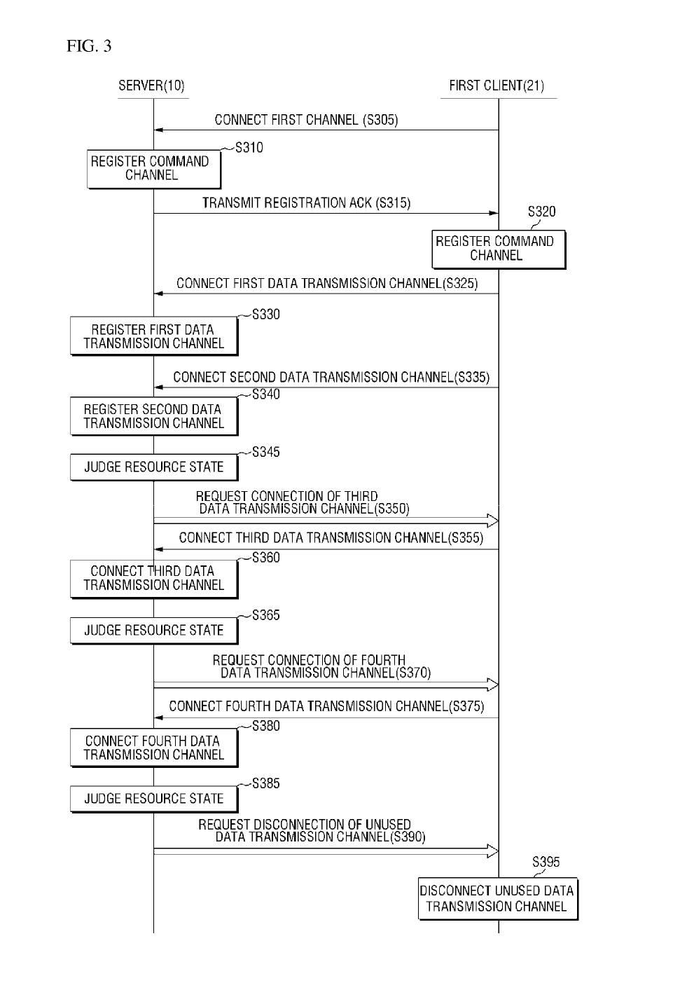

FIG. 3 is a flowchart illustrating a channel connection management method according to another embodiment of the present invention.

Referring to FIGS. 2 and 3, operations S305 through S330 of FIG. 3 are identical or similar to operations S205 through S230 of FIG. 2.

That is, a server 10 and a first client 21 connect and register a command channel before connecting and registering a data transmission channel.

After the connection and registration of the command channel, the first client 21 may connect a first data transmission channel.

The first client 21 can connect an additional data transmission channel for fast data transmission and reception.

That is, the first client 21 may connect a second data transmission channel (operation S335).

The server 10 may register the connected second data transmission channel (operation S340).

When the resource state of the server 10 indicates that an additional data transmission channel can be connected, the server 10 may transmit a signal for requesting the connection of an additional data transmission channel for efficient and fast data transmission or reception to the first client 21.

That is, the server 10 may transmit a signal for requesting the connection of a third data transmission channel to the first client 21 (operation S350).

A signal for requesting the connection of an additional data transmission channel (e.g., the third data transmission channel) is included in a preset command signal.

Therefore, the server 10 may transmit the signal for requesting the connection of the third data transmission channel to the first client 21 through the command channel.

As in FIG. 2, thick arrows indicate signals transmitted through the command channel.

In response to the signal for requesting the connection of the third data transmission channel, the first client 21 may connect the third data transmission channel unless it is in a situation in which an additional channel cannot be connected (operation S355).

The first client 21 may transmit or receive data using the connected first through third data transmission channels.

The situation in which an additional channel cannot be connected may be, for example, a situation in which a predetermined maximum number of data transmission channels that can be connected is exceeded, a situation in which the first client 21 has a lack of resources, or a situation in which transmission and reception of data are terminated.

The server 10 may register the third data transmission channel and judge its resource state again (operation S365).

When the resource state of the server 10 indicates that another additional channel can be connected, the server 10 may transmit a signal for requesting the connection of an additional data transmission channel (e.g., a fourth data transmission channel) to the first client 21 through the first command channel (operation S370).

That is, even if the first client 21 does not connect an additional channel, when the server 10 judges that it is in a good state to connect an additional channel, it may induce the first client 21 to connect an additional data transmission channel for fast data transmission and reception.

The first client 21 may connect the fourth data transmission channel (operation S375).

The server 10 may register the connected fourth data transmission channel (operation S380).

The first client 21 may transmit or receive data through the connected first through fourth data transmission channels.

After the registration of the fourth data transmission channel, the server 10 may judge its resource state (operation S380).

When resources of the server 10 are lacking or not enough or when the server 10 does not have data to transmit, the server 10 may transmit a signal for requesting the disconnection of an unused data transmission channel to the first client 21 through the command channel (operation S390).

In response to the signal received from the sever 10, the first client 21 disconnects the unused data transmission channel (operation S395).

Alternatively, even if the server 10 does not perform the process of judging its resource state, when the server 10 does not have data to transmit or periodically or non-periodically, the server 10 may transmit the signal for requesting the disconnection of the unused data transmission channel to the first client 21 through the command channel. This is to manage unused channels periodically or non-periodically. The unused channels can be managed and connected to other clients that need the channels.

Since the server 10 induces the disconnection of unused channels, the problem of too many channels connected by a client can be solved.

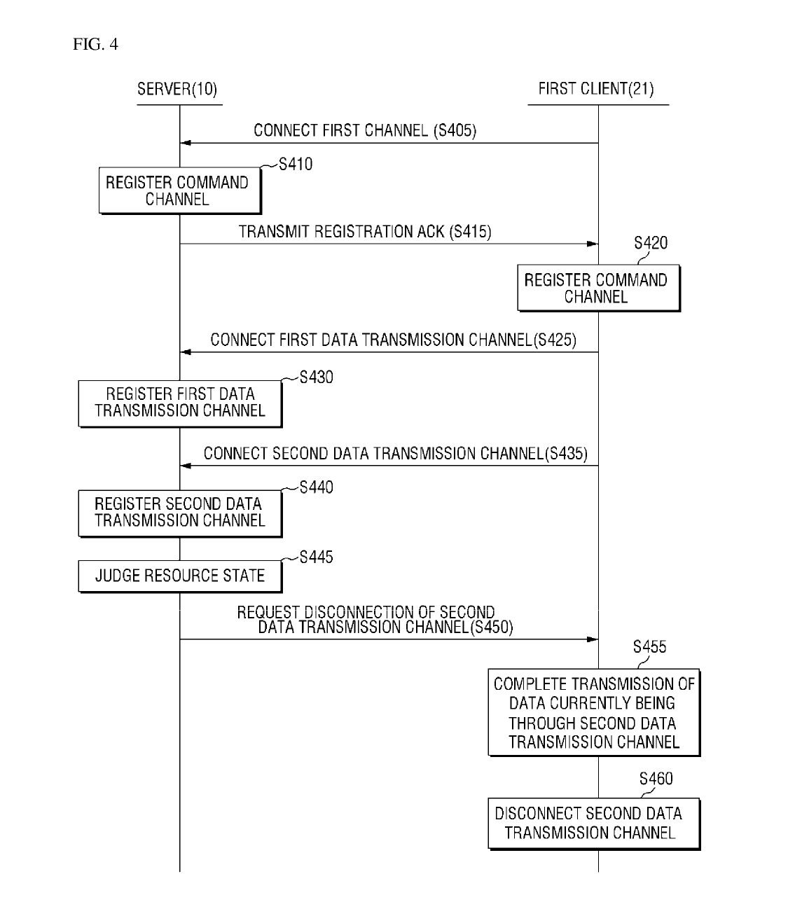

FIG. 4 is a flowchart illustrating a channel connection management method according to another embodiment of the present invention.

In FIG. 4, an example of a situation in which and a method by which a server 10 disconnects a data transmission channel currently being used will be described.

Operations S405 through S445 of FIG. 4 are identical to operations S305 through S345 of FIG. 3.

The server 10 judges its resource state (operation S445).

When the resource state of the server 10 indicates that normal data transmission or reception is impossible due to overload or that overload is expected, the server 10 may request the disconnection of a data transmission channel currently being used (operation S450).

In a case where the resource state of the server 10 is an overload state or is expected to be the overload state, a data transmission channel may be disconnected when the resource state is at a preset level.

Specifically, the server 10 may transmit a signal for requesting the connection of a second data transmission channel to a first client 21 through a first command channel.

In response to the signal for requesting the disconnection of the second data transmission channel, the first client 21 may disconnect the second data transmission channel (operation S460) after the transmission of data currently being transmitted through the second data transmission channel is completed (operation S455).

That is, when the transmission of the data currently being transmitted is completed, the first client 21 may disconnect the second data transmission channel without transmitting another data through the second data transmission channel.

By controlling channel connection using the channel connection management method described above with reference to FIG. 4, the server 10 can prevent its overload and can transmit and receive data as normally as possible. When the channel connection management method described above with reference to FIG. 4 is not used, if the server 10 is under overload, clients connected to the server 10 cannot transmit and receive data normally.

When receiving a channel disconnection request signal from the server 10 through a command channel, a client disconnects a channel unless it is in special circumstances.

FIG. 5 is a block diagram of a channel connection management apparatus 100 according to an embodiment of the present invention.

Referring to FIG. 5, the channel connection management apparatus 100 may include a command channel registration unit 110, a resource state judgment unit 120, a channel connection request unit 130, a data transmission/reception unit 140, and a channel disconnection unit 150.

The channel connection management apparatus 100 to be described with reference to FIG. 5 may employ the channel connection management method described above with reference to FIGS. 2 through 4.

The channel connection management apparatus 100 may be included in a server 10.

The command channel registration unit 110 registers a command channel.

The command channel may exist for each client 20 connected to the server 10.

The resource state judgment unit 120 may judge the resource state of the server 10.

When the judged resource state of the server 10 indicates that an additional channel can be connected, the channel connection request unit 130 may transmit a signal for requesting the connection of an additional channel to the clients 20 through the command channels.

In addition, when data to be transmitted to a particular client 20 is available, the channel connection request unit 130 may transmit a signal for requesting the connection of a channel to the particular client 20 through the command channel.

The data transmission/reception unit 140 may transmit or receive data using a currently connected data transmission channel.

When an additional channel is connected in response to a request signal from the channel connection request unit 130, the channel connection request unit 130 may transmit intended data through the additionally connected channel.

When the transmission of the intended data is completed, the channel disconnection unit 150 may transmit a signal for requesting the disconnection of the additionally connected channel in response to a request signal from the channel connection request unit 130. Specifically, the channel disconnection unit 150 may transmit a signal for requesting the disconnection of a channel to a client 20 connected to a command channel through the command channel.

In addition, when the resource state of the server 10 is an overload state or is expected to be the overload state, the channel disconnection unit 150 may transmit to the clients 20 a signal for requesting the disconnection of all or some of the channels currently being used.

In addition, the channel disconnection unit 150 may transmit a signal for requesting the disconnection of unused channels to the clients 20 through the command channels.

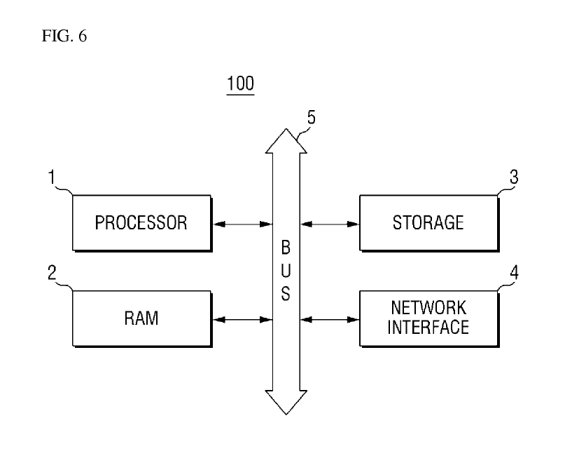

FIG. 6 illustrates another configuration of the channel connection management apparatus of FIG. 5.

The channel connection management apparatus 100 can be configured as illustrated in FIG. 6.

The channel connection management apparatus 100 may include a processor 1 which executes commands, a memory 2 such as a random access memory (RAM), a storage 3 which stores program data, a network interface 4 which is used to transmit or receive data to or from an external device, and a data bus 5 which is connected to the processor 1 and the memory 2 and used as a data transmission path.

According to embodiments of the present invention, the server 10 can actively manage channels.

In addition, according to embodiments of the present invention, the number of channels connected between the server 10 and a client can be increased or reduced according to the situation of the server 10. Accordingly, the safety of the server 10 can be ensured.

According to embodiments of the present invention, the number of connected channels can be increased or reduced regardless of data load.

According to embodiments of the present invention, even when a malignant client connects a large number of channels to the server 10, the server 10 can actively disconnect the connected channels.

Each component of FIG. 5 means, but is not limited to, a software component or a hardware component such as a Field Programmable Gate Array (FPGA) or Application Specific Integrated Circuit (ASIC). A component may advantageously be configured to reside on the addressable storage medium and configured to execute on one or more processors. The functionality provided for in the components may be combined into fewer components or further separated into additional components.

According to embodiments of the present invention, a server can actively manage channels.

In addition, according to embodiments of the present invention, the number of channels connected between the server and a client can be increased or reduced according to the situation of the server. Accordingly, the safety of the server can be ensured.

According to embodiments of the present invention, the number of connected channels can be increased or reduced regardless of data load.

According to embodiments of the present invention, even when a malignant client connects a large number of channels to the server, the server can actively disconnect the connected channels.

However, the effects of the present invention are not restricted to the one set forth herein. The above and other effects of the present invention will become more apparent to one of daily skill in the art to which the present invention pertains by referencing the claims.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A channel connection management method comprising:
registering a first command channel which is connected between a server and a first client; and
transmitting a signal for requesting a connection of a data transmission channel to the first client through the first command channel.

2. The method of claim 1, wherein the first command channel remains continuously connected while the server and the first client are linked to each other.

3. The method of claim 1, wherein the first command channel is limited to transmit a preset command signal which comprises a signal for requesting channel connection and a signal for requesting channel disconnection.

4. The method of claim 1, wherein in the transmitting of the signal for requesting the connection of the data transmission channel, the signal for requesting the connection of the data transmission channel is transmitted when the server has data to transmit to the first client.

5. The method of claim 4, wherein the data transmission channel is a first data transmission channel, the method further comprising judging a resource state of the server, wherein when the judged resource state indicates that a second data transmission channel can be connected, a signal for requesting a connection of the second data transmission channel is transmitted in the transmitting of the signal for requesting the connection of the first data transmission channel.

6. The method of claim 5, further comprising transmitting a signal for requesting a disconnection of an unused channel through the first command channel.

7. The method of claim 6, wherein in the judging of the resource state of the server, the resource state of the server is judged after the unused channel is disconnected in response to the signal for requesting the disconnection of the unused channel.

8. The method of claim 1, further comprising:
transmitting a data through the data transmission channel when the data transmission channel is connected in response to the signal for requesting the connection of the data transmission channel; and
transmitting a signal, after the transmitting of the data is completed, for requesting a disconnection of the data transmission channel, which was connected in response to the signal for requesting the connection of the data transmission channel.

9. The method of claim 5, further comprising, when the judged resource state of the server indicates that at least one of the channels connected to the first client needs to be disconnected, transmitting a signal for requesting a disconnection of the at lest one of the channels connected to the first client through the first command channel.

10. A channel connection management method comprising:
registering a first command channel connected between a server and a first client;
judging a resource state of the server; and
transmitting a signal for requesting a disconnection of at least one of the data transmission channels currently being used through the first command channel when the judged resource state of the server is at a preset level.

11. The method of claim 10, wherein the transmitting of the signal for requesting the disconnection of the at least one of the data transmission channels currently being used comprises transmitting a signal for requesting the first client to disconnect the one of the at least one of the data transmission channels after the transmission of data currently being transmitted through the one of the at least one of the data transmission channels is completed.

12. A channel connection management apparatus comprising:
a command channel registration unit which registers a first command channel which is connected between a server and a first client; and
a channel connection request unit which transmits a signal for requesting a connection of a data transmission channel to the first client through the first command channel.

13. The apparatus of claim 12, wherein when the server has data to transmit to the first client, the channel connection request unit transmits the signal for requesting the connection of the data transmission channel.

14. The apparatus of claim 13, further comprising:
a data transmission and reception unit which transmits the data through the data transmission channel when the data transmission channel is connected in response to the signal for requesting the connection of the data transmission channel; and
a connection request transmission unit which transmits a signal for requesting a disconnection of the data transmission channel, which was connected in response to the signal for requesting the connection of the data transmission channel, after the transmission of the data is completed.

15. The apparatus of claim 12, further comprising a disconnection request unit which transmits a request for requesting a disconnection of an unused channel through the first command channel.

16. The apparatus of claim 12, further comprising a channel disconnection request unit which, when a judged resource state of the server indicates that at least one of channels connected to the first client need to be disconnected, transmits a signal for requesting a disconnection of the at least one of the channels connected to the first client to the first client through the first command channel.

17. A channel connection management apparatus comprising:
a command channel registration unit which registers a first command channel which is connected between a server and a first client;
a disconnection request unit which transmits a signal for requesting a disconnection of a data transmission channel that is unused for more than a preset period of time to the first client through the first command channel; and
a resource state judgment unit which judges a resource state of the server after the unused data transmission channel is disconnected,
wherein when the judged resource state of the server is at a preset level, the disconnection request unit transmits a signal for requesting a disconnection of at least one of data transmission channels currently being used to the first client through the first command channel.
